(19) United States
(12) Patent Application Publication
(10) Pub. No.: US 2020/0297106 A1
(43) Pub. Date: Sep. 24, 2020

(54) Alternated magnetic polarity oral care devices

(71) Applicant: Henryk Malak, Ellicott City, MD (US)

(72) Inventor: Henryk Malak, Ellicott City, MD (US)

(21) Appl. No.: 16/501,292

(22) Filed: Mar. 20, 2019

(51) Int. Cl. A46B 11/00; A61Q 11/00

(52) U.S. Cl. CPC A46B 11/0006; A61C 17/221; A61Q 11/00

(57) ABSTRACT

This invention relates to novel oral care devices that are based upon alternated magnetic polarity magnetic elements built into oral care devices, which provide very effective removal oral plaque, tooth tartar and oral bacteria.

### CROSS REFERENCE TO RELATED PATENT APPLICATION

This application claims the benefit of U.S. Provisional Application Ser. No. 62/761,330 filed Mar. 19, 2018, entitled “Personal Care Devices”, which is incorporated by reference.

### FIELD OF THE INVENTION

This invention is generally related to oral care devices.

### BACKGROUND OF THE INVENTION

The oral care benefits have been known for a long time, and therefore, there are oral care devices on the market for improving human and animal health. Most of these devices mechanically remove tooth plaque, tongue plaque, tooth tartar and oral bacteria. However, the oral plaque is very sticky and therefore these devices are very abrasive, causing oral tissue lost and dental cavities. For these reasons, there exists a strong need for less abrasive and more effective oral hygienic-therapeutic devices. In this invention we addressed magnetic properties of the oral plaque, which can be used to less abrasive and more effective plaque removal by interaction of the magnetic plaque with an external magnetic field. Furthermore, the invention relates to alternating magnetic polarity of the external magnetic field that will further minimize the stickiness of the oral plaque due to magnetic polarity reorientations and magnetic hysteresis in the oral plaque.

### SUMMARY OF THE INVENTION

The invention discloses novel oral care devices that are based upon alternated magnetic polarity. The proposed devices address magnetic properties of oral plaque, tartar and oral bacteria, which can be effectively removed by the devices with alternated magnetic polarity magnetic field.

### DESCRIPTION OF PREFERRED EMBODIMENTS

All patents, patent applications, and literature cited or referenced in this description are incorporated herein by reference in their entireties. In the case of inconsistencies, the present disclosure, including definitions and usage, will control.

The disclosure generally describes novel oral care devices that are based upon alternating magnetic polarity of a magnetic element that is built into the oral care device. The magnetic element, preferred an electromagnetic element, is radiating magnetic field with an alternated magnetic polarity towards oral plaque. The magnetic polarity is changed at a specific frequency selected from 0.01 Hz to 10 GHz, and the frequency is selected depends on purposes of oral care.

The scope of the invention includes oral care device selected from the group of a toothbrush, a wand or a mouthpiece.

The magnetic element is placed in the distal ends of the toothbrush (toothbrush bristles) and wand allowing magnetic radiation to radiate oral plaque during the device movement, but in the mouthpiece the magnetic elements are placed in few places on the mouthpiece allowing magnetic radiation penetrate effectively dental plaque and oral bacteria.

The electromagnetic element changes its magnetic polarity by alternated current to which the electromagnetic element is connected.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An alternated magnetic polarity oral care device selected from the group of a toothbrush, a wand or a mouthpiece comprising: an oral care device and a magnetic element, wherein the magnetic element is built into oral care device and is capable to radiate magnetic field with alternated magnetic polarity at a specific frequency for the purpose of oral care.

2. The alternated magnetic polarity oral care device of claim 1, wherein the magnetic element is at least one electromagnetic element.

3. The alternated magnetic polarity, oral care device of claim 1, wherein the specific frequency of alternating magnetic polarity is selected from a range of 0.01 Hz to 10 GHz.

4. The alternated magnetic polarity oral care device of claim 1, wherein the specific frequency is a plurality of frequencies.

5. The alternated magnetic polarity oral care device of claim 5, wherein the plurality of frequencies is selected for oral care purposes.
